(19) United States
(12) Patent Application Publication
(10) Pub. No.: US 2015/0350126 A1
(43) Pub. Date: Dec. 3, 2015

(54) METHOD AND DEVICE FOR USING LOG INFORMATION

(71) Applicant: HUAWEI TECHNOLOGIES CO., LTD., Shenzhen (CN)

(72) Inventor: Yuan XUE, Shenzhen (CN)

(21) Appl. No.: 14/726,241

(22) Filed: May 29, 2015

(30) Foreign Application Priority Data
May 30, 2014 (CN) 201410240521.4

(51) Int. Cl. H04L 12/58; H04L 29/08

(52) U.S. Cl. CPC H04L 51/043; H04L 51/046; H04L 67/22

(57) ABSTRACT

The present invention discloses a method and device for using log information, acquiring log information; and sending the log information to a first instant messaging client, so that the first instant messaging client displays the working status of the user according to the log information. In this way, the log information of the user is displayed in an instant messaging client that has an instant messaging identifier of the user. When the user performs communication by using instant messaging software, a peer end in communication can acquire a future status of the user in time, and the user can acquire a future status of the peer end in communication in time, which helps either communication party select an appropriate time to initiate communication with a peer end in communication, thereby greatly enhancing efficiency of communication performed by using the instant messaging software.

### CROSS-REFERENCE TO RELATED APPLICATIONS

This application claims priority to Chinese Patent Application No. 201410240521.4, filed with the Chinese Patent Office on May 30, 2014, which is incorporated herein by reference in its entirety.

### TECHNICAL FIELD

The present invention relates to the field of Internet communications technologies, and in particular, to a method and device for using log information.

### BACKGROUND

In today's society, people's life and work are filled with all types of office software and social networks, and interpersonal interaction and communication are increasingly relying on the Internet. In general, people communicate on the Internet by using some communication software, such as, instant messaging software QQ developed by Tencent, FeiQ instant messaging software, and instant messaging software aliww. However, when people communicate on the Internet by using communication software, whether both communication parties are simultaneously using the same communication software, and states of both communication parties become crucial to whether a communication session can go smoothly.

It is assumed that a user A and a user B separately have an instant messaging software QQ account and are “friends” in the instant messaging software QQ. When the user A initiates a conversation with the user B by using the instant messaging software QQ, if the user B does not log in to the instant messaging software QQ, the user B cannot see, in time, a conversation message that is sent by the user A to the user B, which means that a reply of the user B cannot be obtained in time. In this case, communication between the user A and the user B cannot be smoothly implemented on the Internet, thereby causing low efficiency of the communication performed by using the Internet.

### SUMMARY

In view of this, embodiments of the present invention provide a method and device for using log information, so as to resolve a current problem that the communication efficiency is low when a user performs communication on the Internet by using instant messaging software.

According to a first aspect of the present invention, a method for using log information is provided, including:

acquiring log information, which is corresponding to an instant messaging identifier, of a user, where the log information includes a time unit and a working status of the user in the time unit; and

sending the log information to a first instant messaging client, so that the first instant messaging client presents the working status of the user according to the log information, where the instant messaging identifier is corresponding to an instant messaging object included in the first instant messaging client.

With reference to the first aspect of the present invention, in a first possible implementation manner of the first aspect of the present invention, before the acquiring log information, which is corresponding to an instant messaging identifier, of a user, the method further includes:

receiving a log information acquiring request sent by the first instant messaging client, where the log information acquiring request includes the instant messaging identifier; and

sending a log query request that carries the instant messaging identifier to a log server; where

the acquiring log information, which is corresponding to an instant messaging identifier, of a user includes:

receiving the log information that is sent by the log server and is corresponding to the instant messaging identifier.

With reference to the first aspect of the present invention, in a second possible implementation manner of the first aspect of the present invention, before the acquiring log information, which is corresponding to an instant messaging identifier, of a user, the method further includes:

receiving a log information acquiring request sent by the first instant messaging client, where the log information acquiring request includes the instant messaging identifier; and

sending, to a second instant messaging client corresponding to the instant messaging identifier, a log query request that carries the instant messaging identifier; where

the acquiring log information, which is corresponding to an instant messaging identifier, of a user includes:

receiving the log information that is sent by the second instant messaging client corresponding to the instant messaging identifier and is corresponding to the instant messaging identifier.

With reference to the first aspect of the present invention, or with reference to the first possible implementation manner of the first aspect of the present invention, or with reference to the second possible implementation manner of the first aspect of the present invention, in a third possible implementation manner of the first aspect of the present invention, the log information of the user includes the time unit and the working status of the user in the time unit; and

the sending the log information to a first instant messaging client includes:

sending the time unit and the working status of the user in the time unit to the first instant messaging client.

According to a second aspect of the present invention, a method for using log information is provided, including:

receiving, by a first instant messaging client, log information, which is corresponding to an instant messaging identifier, of a user, where the log information includes a time unit and a working status of the user in the time unit; and

displaying the working status of the user according to the log information, where the instant messaging identifier is corresponding to an instant messaging object included in the first instant messaging client.

With reference to the second aspect of the present invention, in a first possible implementation manner of the second aspect of the present invention, before the receiving, by a first instant messaging client, log information, which is corresponding to an instant messaging identifier, of a user, the method further includes:

sending, by the first instant messaging client, a log information acquiring request, where the log information acquiring request includes the instant messaging identifier.

With reference to the second aspect of the present invention, or with reference to the first possible implementation manner of the second aspect of the present invention, in a second possible implementation manner of the second aspect of the present invention, the receiving, by a first instant messaging client, log information, which is corresponding to an instant messaging identifier, of a user includes:

receiving, by the first instant messaging client, the time unit and the working status of the user in the time unit, where the user is corresponding to the instant messaging identifier; and

the displaying the working status of the user according to the log information includes:

displaying, in a time sequence and near an icon location corresponding to the instant messaging identifier of the user, the time unit and the working status of the user in the time unit.

According to a third aspect of the present invention, a device for using log information is provided, where the device includes:

an acquiring module, configured to acquire log information, which is corresponding to an instant messaging identifier, of a user, where the log information includes a time unit and a working status of the user in the time unit; and

a sending module, configured to send the log information acquired by the acquiring module to a first instant messaging client, so that the first instant messaging client displays the working status of the user according to the log information, where the instant messaging identifier is corresponding to an instant messaging object included in the first instant messaging client.

With reference to the third aspect of the present invention, in a first possible implementation manner of the third aspect of the present invention, the device further includes:

a log query request sending module, configured to, before the log information, which is corresponding to the instant messaging identifier, of the user is acquired, receive a log information acquiring request sent by the first instant messaging client, where the log information acquiring request includes the instant messaging identifier; and send a log query request that carries the instant messaging identifier to a log server; where

the acquiring module is specifically configured to receive the log information that is sent by the log server and is corresponding to the instant messaging identifier.

With reference to the third aspect of the present invention, in a second possible implementation manner of the third aspect of the present invention, the device further includes:

a log query request sending module, configured to, before the log information, which is corresponding to the instant messaging identifier, of the user is acquired, receive a log information acquiring request sent by the first instant messaging client, where the log information acquiring request includes the instant messaging identifier; and send, to a second instant messaging client corresponding to the instant messaging identifier, a log query request that carries the instant messaging identifier; where

the acquiring module is specifically configured to receive the log information that is sent by the second instant messaging client corresponding to the instant messaging identifier and is corresponding to the instant messaging identifier.

With reference to the third aspect of the present invention, or with reference to the first possible implementation manner of the third aspect of the present invention, or with reference to the second possible implementation manner of the third aspect of the present invention, in a third possible implementation manner of the third aspect of the present invention, the log information of the user includes the time unit and the working status of the user in the time unit; and

the sending module is specifically configured to send the time unit and the working status of the user in the time unit to the first instant messaging client.

According to a fourth aspect of the present invention, a device for using log information is provided, where the device includes:

a receiving module, configured to receive log information, which is corresponding to an instant messaging identifier, of a user, where the log information includes a time unit and a working status of the user in the time unit; and

a display module, configured to present the working status of the user according to the log information received by the receiving module, where the instant messaging identifier is corresponding to an instant messaging object included in a first instant messaging client.

With reference to the fourth aspect of the present invention, in a first possible implementation manner of the fourth aspect of the present invention, the device further includes:

an acquiring request sending module, configured to, before the log information, which is corresponding to the instant messaging identifier, of the user is received, send a log information acquiring request, where the log information acquiring request includes the instant messaging identifier.

With reference to the fourth aspect of the present invention, or with reference to the first possible implementation manner of the fourth aspect of the present invention, in a second possible implementation manner of the fourth aspect of the present invention, the receiving module is specifically configured to receive the time unit and the working status of the user in the time unit, where the user is corresponding to the instant messaging identifier; and

the display module is specifically configured to display, in a time sequence and near an icon location corresponding to the instant messaging identifier of the user, the time unit and the working status of the user in the time unit.

According to a fifth aspect of the present invention, a device for using log information is provided, where the device includes:

a memory, configured to store application program code; and

a processor, configured to execute the application program code stored in the memory, which is specifically configured to:

acquire log information, which is corresponding to an instant messaging identifier, of a user, where the log information includes a time unit and a working status of the user in the time unit; and

send the log information to a first instant messaging client, so that the first instant messaging client displays the working status of the user according to the log information, where the instant messaging identifier is corresponding to an instant messaging object included in the first instant messaging client.

With reference to the fifth aspect of the present invention, in a first possible implementation manner of the fifth aspect of the present invention, the processor is further configured to:

before the log information, which is corresponding to the instant messaging identifier, of the user is acquired, receive a log information acquiring request sent by the first instant messaging client, where the log information acquiring request includes the instant messaging identifier;

send a log query request that carries the instant messaging identifier to a log server; and

receive the log information that is sent by the log server and is corresponding to the instant messaging identifier.

With reference to the fifth aspect of the present invention, in a second possible implementation manner of the fifth aspect of the present invention, the processor is further configured to:

before the log information, which is corresponding to the instant messaging identifier, of the user is acquired, receive a log information acquiring request sent by the first instant messaging client, where the log information acquiring request includes the instant messaging identifier;

send, to a second instant messaging client corresponding to the instant messaging identifier, a log query request that carries the instant messaging identifier; and

receive the log information that is sent by the second instant messaging client corresponding to the instant messaging identifier and is corresponding to the instant messaging identifier.

With reference to the fifth aspect of the present invention, or with reference to the first possible implementation manner of the fifth aspect of the present invention, or with reference to the second possible implementation manner of the fifth aspect of the present invention, in a third possible implementation manner of the fifth aspect of the present invention, the log information of the user includes the time unit and the working status of the user in the time unit; and

the processor is specifically configured to:

send the time unit and the working status of the user in the time unit to the first instant messaging client.

According to a sixth aspect of the present invention, a device for using log information is provided, where the device includes:

a memory, configured to store application program code; and

a processor, configured to execute the application program code in the memory, which is specifically configured to:

receive log information, which is corresponding to an instant messaging identifier, of a user, where the log information includes a time unit and a working status of the user in the time unit; and

display the working status of the user according to the log information, where the instant messaging identifier is corresponding to an instant messaging object included in a first instant messaging client.

With reference to the sixth aspect of the present invention, in a first possible implementation manner of the sixth aspect of the present invention, the processor is further configured to:

before the log information, which is corresponding to the instant messaging identifier, of the user is received, send a log information acquiring request, where the log information acquiring request includes the instant messaging identifier.

With reference to the sixth aspect of the present invention, or with reference to the first possible implementation manner of the sixth aspect of the present invention, in a second possible implementation manner of the sixth aspect of the present invention, the processor is specifically configured to:

receive the time unit and the working status of the user in the time unit, where the user is corresponding to the instant messaging identifier; and

display, in a time sequence and near an icon location corresponding to the instant messaging identifier of the user, the time unit and the working status of the user in the time unit.

It can be learned from the foregoing that, in the embodiments of the present invention, log information, which is corresponding to an instant messaging identifier, of a user is acquired, where the log information includes a time unit and a working status of the user in the time unit; and the log information is sent to a first instant messaging client, so that the first instant messaging client displays the working status of the user according to the log information, where the instant messaging identifier is corresponding to an instant messaging object included in the first instant messaging client. In this way, the log information of the user is displayed in an instant messaging client that has an instant messaging identifier of the user. When the user performs communication by using instant messaging software, a peer end in communication can acquire a future status of the user in time, and the user can acquire a future status of the peer end in communication in time, which helps either communication party select an appropriate time to initiate communication with a peer end in communication, thereby greatly enhancing efficiency of communication performed by using the instant messaging software.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of a method for using log information according to Embodiment 1 of the present invention;

FIG. 2 is a schematic flowchart of a method for using log information according to Embodiment 2 of the present invention;

FIG. 3 is a schematic diagram of log information recorded on an icon location corresponding to an instant messaging identifier;

FIG. 4 is a schematic structural diagram of a device for using log information according to Embodiment 3 of the present invention;

FIG. 5 is a schematic structural diagram of a device for using log information according to Embodiment 4 of the present invention;

FIG. 6 is a schematic structural diagram of a device for using log information according to Embodiment 5 of the present invention; and

FIG. 7 is a schematic structural diagram of a device for using log information device according to Embodiment 6 of the present invention.

### DESCRIPTION OF EMBODIMENTS

To achieve the objective of the present invention, embodiments of the present invention provide a method and device for using log information. Log information, which is corresponding to an instant messaging identifier, of a user is acquired, where the log information includes a time unit and a working status of the user in the time unit; and the log information is sent to a first instant messaging client, so that the first instant messaging client displays the working status of the user according to the log information, where the instant messaging identifier is corresponding to an instant messaging object included in the first instant messaging client. In this way, the log information of the user is displayed in an instant messaging client that has an instant messaging identifier of the user. When the user performs communication by using instant messaging software, a peer end in communication can acquire a future status of the user in time, and the user can acquire a future status of the peer end in communication in time, which helps either communication party select an appropriate time to initiate communication with a peer end in communication, thereby greatly enhancing efficiency of communication performed by using the instant messaging software.

In fact, to avoid a problem that the communication efficiency is low when instant messaging software is used for communication, several manners are currently proposed:

Manner 1: a manual setting manner. That is, a user sets different user statuses for instant messaging software in use according to his or her actual requirements.

The user statuses include: online (that is, a state in which communication can be successfully performed), invisible (that is, viewed as offline by the other party; however, once the other party sends a message, it can be viewed in time), busy (that is, a state when there is much work to do and it is inappropriate for communication), away (that is, a state in which a communication message cannot be viewed in time), offline, and the like.

For example, when the user logs in to the instant messaging software, the user may manually set the state to online or invisible; when it is necessary to temporarily leave a device in which the instant messaging software resides, the user may manually change the online or invisible state to away; and when there is much work to do and the user does not want to be disturbed by the other party, the user may manually change the online or invisible state to busy.

It may be seen that, if the manual setting manner is used to set a user status, the user needs to change the user status in real time according to a change in the status of the user. However, it is inevitable that when the status changes, the user may not be able to change the user status in the instant messaging software in time, and therefore one communication party cannot accurately acquire a user status of the other party, thereby causing a problem of low conversation and communication efficiency.

Manner 2: a user status automatically set by an external device. That is, after a user logs in to instant messaging software, the user uses the external device to trace or recognize a user status, and the traced or recognized user status is displayed in the instant messaging software.

For example, a camera is installed outside a device (such as a PC) in which the instant messaging software resides, and the head or body of the user is scanned by using the installed camera. When the head or body of the user can be scanned, it is determined that the current status of the user is online, and it is displayed in the instant messaging software that the user is in the online state. When the user leaves, the head or body of the user cannot be scanned; therefore, it is determined that the current status of the user is offline, and it is displayed in the instant messaging software that the user is in the offline state.

It may be seen that, if the manner in which a user status is automatically set by an external device is used, a user status can be changed in real time, but a case in which the user status frequently changes occurs when automatic tracing is used for status recognition, and therefore it becomes increasingly difficult for one communication party to determine a user status of the other communication party, and a problem of low conversation and communication efficiency still exists.

It may be seen that it is fairly necessary to propose the technical solutions of the present invention. It should be noted that, log information described in the embodiments of the present invention may be pre-stored by a user on a log server, where a correspondence between an instant messaging identifier of the user and the log information of the user is established on the log server, and the log information may also be pre-stored by the user in an instant messaging client, which is not limited herein.

The log server may be an OUTLOOK server, or may be another server that has a log storing function, which is not limited herein.

The log information here, explained in a broader sense, may be a business schedule, may be a working conference arrangement, and may also be a life arrangement, and the like.

The following describes in detail the embodiments of the present invention with reference to the accompanying drawings in the specification. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

### Embodiment 1

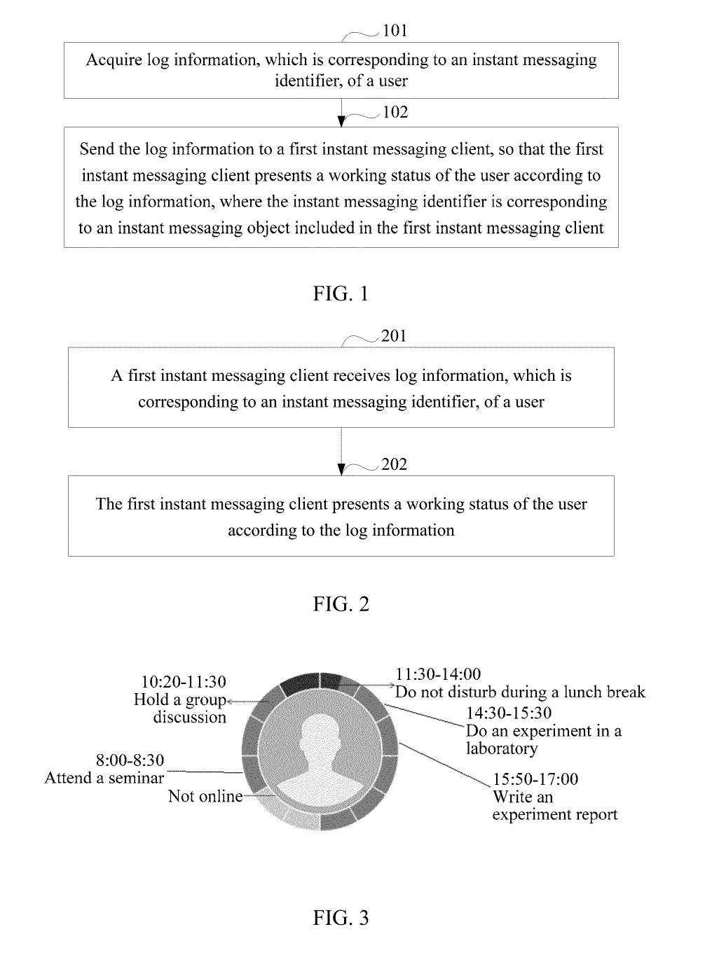

As shown in FIG. 1, FIG. 1 is a schematic flowchart of a method for using log information according to Embodiment 1 of the present invention. The method can be described as follows:

Step 101: Acquire log information, which is corresponding to an instant messaging identifier, of a user.

The log information includes a time unit and a working status of the user in the time unit.

It should be noted that, the time unit here may be a time point or a time period; or may be time including such content as year, month, day, hour, minute, or second; or may be time including content from Monday to Sunday, which is not limited herein.

The working status here refers to work content that is being handled by the user in one time unit, for example, a conference, a group study, or an experiment. Working statues corresponding to different time units may be or may not be the same. The user sets out the work content in advance, establishes a correspondence between the time unit and the working status, and stores the correspondence as the log information.

The log information may be stored on a log server, or may be stored on another server except the log server, which is not limited herein.

When the log server stores multiple pieces of log information of different users, establishing a correspondence between an instant messaging identifier of a user and log information of the user may be establishing a correspondence between multiple instant messaging identifiers of the same user and the log information of the user, or may be establishing a correspondence between one instant messaging identifier of the same user and the log information of the user, which is not limited herein.

In step 101, the log information, which is corresponding to the instant messaging identifier, of the user may be acquired in the following manners:

Manner 1: The log information, which is corresponding to the instant messaging identifier, of the user is acquired from a log server, where the log server stores the log information corresponding to the instant messaging identifier.

Step (1): Receive a log information acquiring request sent by a first instant messaging client.

The log information acquiring request includes the instant messaging identifier.

It should be noted that, a manner of receiving the log information acquiring request sent by the first instant messaging client includes but is not limited to:

triggering a log information acquiring request control in the first instant messaging client, which is considered that the log information acquiring request sent by the first instant messaging client is received; or

receiving login request information sent by the first instant messaging client, which is considered that the log information acquiring request sent by the first instant messaging client is received, where the login request information carries log information acquiring indication information.

The login request information includes the instant messaging identifier.

Step (2): Send a log query request that carries the instant messaging identifier to the log server.

The log server stores log information corresponding to the instant messaging identifier.

Specifically, a communication connection is established between an instant messaging server and the log server. When the log information acquiring request sent by the first instant messaging client is received, the log query request is generated and sent to the log server, where the log query request carries the instant messaging identifier.

Step (3): Receive the log information that is sent by the log server and is corresponding to the instant messaging identifier.

Specifically, the first instant messaging client receives the log information that is sent by the log server and is corresponding to the instant messaging identifier.

The log server stores the log information corresponding to the instant messaging identifier; therefore, when receiving the log query request, the log server searches, according to the stored log information corresponding to the instant messaging identifier, and checks whether the log information corresponding to the instant messaging identifier exists. If the log information exists, query result information that includes the log information corresponding to the instant messaging identifier is returned; otherwise, query failure information is returned.

It is assumed that when the instant messaging server receives the login request sent by the first instant messaging client, the instant messaging server needs to use the instant messaging identifier to perform identity verification, and when verification succeeds, the log query request is generated and sent to the log server.

It should be noted that, the log query request information is used to request the log information corresponding to the instant messaging identifier from the log server.

Manner 2: Acquire the log information, which is corresponding to the instant messaging identifier, of the user from a second instant messaging client corresponding to the instant messaging identifier, where the second instant messaging client stores the log information corresponding to the instant messaging identifier.

Step (1): Receive a log information acquiring request sent by the first instant messaging client, where the log information acquiring request includes the instant messaging identifier.

Step (2): Send, to the second instant messaging client corresponding to the instant messaging identifier, a log query request that carries the instant messaging identifier.

Step (3): Receive the log information that is sent by the second instant messaging client corresponding to the instant messaging identifier and is corresponding to the instant messaging identifier.

The second instant messaging client corresponding to the instant messaging identifier stores the log information corresponding to the instant messaging identifier.

That is, the log information of the user may be stored on the log server, or may be stored on the instant messaging client that is used by the user, which is not limited herein.

For example, after logging in to the first instant messaging client, a user A wants to acquire log information of a user B. In one way, the instant messaging server receives the log information acquiring request sent by the first instant messaging client, where the log information acquiring request includes an instant messaging identifier of the user B, and sends, to the log server, a log query request that carries the instant messaging identifier of the user B. In this case, log information that is sent by the log server and is corresponding to the instant messaging identifier of the user B is received, so as to acquire the log information corresponding to the instant messaging identifier of the user B. In another way, the instant messaging server receives the log information acquiring request sent by the first instant messaging client, where the log information acquiring request includes an instant messaging identifier of the user B, sends, to a second instant messaging client corresponding to the instant messaging identifier of the user B (which may be an instant messaging client to which the user B is logging in, or an instant messaging client that stores the log information of the user B, which is not limited herein), a log query request that carries the instant messaging identifier, and receives log information that is sent by the second instant messaging client corresponding to the instant messaging identifier of the user B and is corresponding to the instant messaging identifier, so as to acquire the log information corresponding to the instant messaging identifier of the user B.

Step 102: Send the log information to a first instant messaging client, so that the first instant messaging client displays a working status of the user according to the log information, where the instant messaging identifier is corresponding to an instant messaging object included in the first instant messaging client.

In step 102, when the log information is received, the log information is sent to the first instant messaging client.

In addition, another instant messaging client that includes the instant messaging identifier is determined according to the instant messaging identifier, and the log information is sent to the determined another instant messaging client.

One instant messaging identifier does not appear on only one instant messaging client; therefore, after the log information, which is corresponding to the instant messaging identifier, of the user is acquired, the log information, which is corresponding to the instant messaging identifier, of the user may also be sent to an instant messaging client that includes the instant messaging identifier and is in a non-offline state.

For example, an instant messaging identifier aa belongs to an instant messaging object included in an instant messaging client A, belongs to an instant messaging object included in an instant messaging client B, and also belongs to an instant messaging object included in an instant messaging client C. It is assumed that after acquiring log information, which is corresponding to the instant messaging identifier aa, of a user, the instant messaging server sends the log information, which is corresponding to the instant messaging identifier aa, of the user to the instant messaging client A; meanwhile, the instant messaging server may also send the log information, which is corresponding to the instant messaging identifier aa, of the user to the instant messaging client B and the instant messaging client C.

It is assumed that, in this case, the instant messaging server determines, according to the instant messaging identifier aa, that an instant messaging client that includes the instant messaging identifier aa is the instant messaging client A.

In this case, log information that is found and is corresponding to the instant messaging identifier aa is sent to the instant messaging client A.

Specifically, the log information of the user includes a time unit and a working status of the user in the time unit, and the time unit and the working status of the user in the time unit are sent to the first instant messaging client.

It should be noted that, the instant messaging client described in this embodiment of the present invention may be an instant messaging client on a PC desktop, or may be an instant messaging application client in a mobile terminal, which is not limited herein.

It should be noted that, “first” and “second” involved in “first instant messaging client” and “second instant messaging client” do not have a special meaning; instead, “first” and “second” are only used to distinguish the instant messaging clients and indicate that “first instant messaging client” and “second instant messaging client” are different instant messaging clients.

According to the solution of Embodiment 1 of the present invention, log information, which is corresponding to an instant messaging identifier, of a user is acquired, where the log information includes a time unit and a working status of the user in the time unit; and the log information is sent to a first instant messaging client, so that the first instant messaging client displays the working status of the user according to the log information, where the instant messaging identifier is corresponding to an instant messaging object included in the first instant messaging client. In this way, the log information of the user is displayed in an instant messaging client that has an instant messaging identifier of the user. When the user performs communication by using instant messaging software, a peer end in communication can acquire a future status of the user in time, and the user can acquire a future status of the peer end in communication in time, which helps either communication party select an appropriate time to initiate communication with a peer end in communication, thereby greatly enhancing efficiency of communication performed by using the instant messaging software.

### Embodiment 2

As shown in FIG. 2, FIG. 2 is a schematic flowchart of a method for using log information according to Embodiment 2 of the present invention. The method can be described as follows:

Step 201: A first instant messaging client receives log information, which is corresponding to an instant messaging identifier, of a user.

The log information includes a time unit and a working status of the user in the time unit.

In step 201, before that a first instant messaging client receives log information, which is corresponding to an instant messaging identifier, of a user, the method further includes:

sending, by the first instant messaging client, a log information acquiring request, where the log information acquiring request includes the instant messaging identifier.

Specifically, the first instant messaging client sends the log information acquiring request to an instant messaging server; the instant messaging server sends a log query request that carries the instant messaging identifier to a log server; and the instant messaging server receives the log information that is sent by the log server and is corresponding to the instant messaging identifier.

It may be seen that the log information, which is received by the first instant messaging client and is corresponding to the instant messaging identifier, of the user is acquired by the instant messaging server from the log server.

Alternatively, the first instant messaging client sends the log information acquiring request to an instant messaging server; the instant messaging server sends, to a second instant messaging client corresponding to the instant messaging identifier, a log query request that carries the instant messaging identifier; and the instant messaging server receives the log information that is sent by the second instant messaging client corresponding to the instant messaging identifier and is corresponding to the instant messaging identifier.

It may be seen that the log information, which is received by the first instant messaging client and is corresponding to the instant messaging identifier, of the user is acquired by the instant messaging server from the second instant messaging client corresponding to the instant messaging identifier.

Specifically, the time unit and the working status of the user in the time unit are received, where the user is corresponding to the instant messaging identifier.

Step 202: The first instant messaging client displays a working status of the user according to the log information.

The user is corresponding to the instant messaging identifier; the instant messaging identifier is corresponding to an instant messaging object included in the first instant messaging client; and the log information includes the time unit and the working status of the user in the time unit.

In step 202, the first instant messaging client displays, in a time sequence and near an icon location corresponding to the instant messaging identifier of the user, the time unit and the working status of the user in the time unit.

For example, the first instant messaging client receives log information of a user A corresponding to an instant messaging identifier aa. In this case, the log information of the user A is displayed near an icon location corresponding to the instant messaging identifier aa of the user A.

In this embodiment of the present invention, a manner in which log information of a user is displayed on an instant messaging client to which another user logs in further includes: receiving log information view request information that is sent by the instant messaging client to which the another user logs in, where the log information view request information includes an instant messaging identifier, which is corresponding to to-be-viewed log information, of a user. In this case, the log information of the user is displayed in a time sequence and on an icon location, where the icon location is corresponding to the instant messaging identifier, which is corresponding to the to-be-viewed log information, of the user.

It should be noted that, the log information view request information that is sent by the instant messaging client to which the another user logs in may be initiating the log information view request information by touching an icon location in the instant messaging client to which the another user logs in, where the icon location is corresponding to the instant messaging identifier, which is corresponding to the to-be-viewed log information, of the user. Alternatively, the log information view request information may be considered to be sent by using a mouse or by using another device to slide into an area in which an icon location is located, where the icon location is corresponding to the instant messaging identifier, which is corresponding to the to-be-viewed log information, of the user.

Specifically, the first instant messaging client generates and displays, according to the time unit included in the log information and in the area in which the icon location is located, a correspondence between the time unit and the working status, where the icon location is corresponding to the instant messaging identifier of the user.

For example, 8:00-8:30 Attend a seminar; 10:20-11:30 Hold a group discussion; 11:30-14:00 Do not disturb during a lunch break; 14:30-15:30 Do an experiment in a laboratory; 15:50-17:00 Write an experiment report; and 17:30 Off duty.

Optionally, the first instant messaging client generates a time flow ring in the area in which the icon location is located, where the icon location is corresponding to the instant messaging identifier of the user. The ring resembles a clock and is divided into 12 grids, and each grid represents one hour. In this way, the foregoing obtained correspondences between the time unit and the working status are respectively displayed in corresponding time grids.

It should be noted that different working statuses may also be marked by different colors.

As shown in FIG. 3, FIG. 3 is a schematic diagram of log information recorded on an icon location corresponding to an instant messaging identifier of a user.

It should be noted that the generated time flow ring may also have another shape, which is not limited to a circle.

Optionally, as time elapses, a working status may change from highlighted display to dimmed display, which means that some working statuses gradually become invalid or have changed as time goes by.

It should be noted that when a user A is in an offline state, in an instant messaging client to which another user (B or C) logs in, because the user A is in the offline state, log information of the user A cannot be viewed; when the user A is in an online state, in the instant messaging client to which the another user (B or C) logs in, because the user A is in the online state, the log information of the user A can be viewed.

It should be noted that the online state, different from the offline state, includes an online state, a busy state, a do not disturb state, and an away state.

According to the solution of Embodiment 2 of the present invention, a first instant messaging client receives log information, which is corresponding to an instant messaging identifier, of a user; displays a working status of the user according to the log information, where the instant messaging identifier is corresponding to an instant messaging object included in the first instant messaging client, and the log information includes a time unit and a working status of the user in the time unit. In this way, the log information of the user is displayed in an instant messaging client that has an instant messaging identifier of the user. When the user performs communication by using instant messaging software, a peer end in communication can acquire a future status of the user in time, and the user can acquire a future status of the peer end in communication in time, which helps either communication party select an appropriate time to initiate communication with a peer end in communication, thereby greatly enhancing efficiency of communication performed by using the instant messaging software.

### Embodiment 3

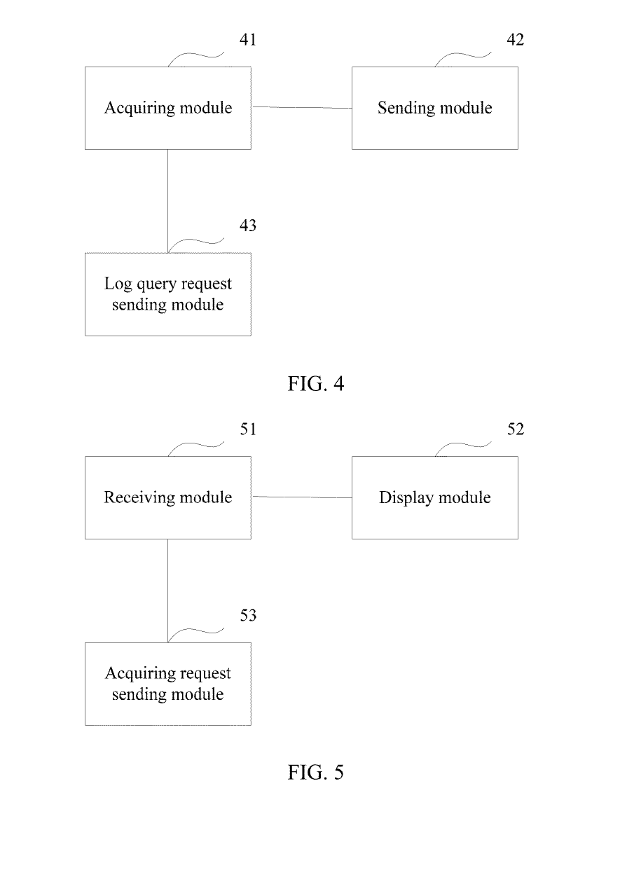

As shown in FIG. 4, FIG. 4 is a schematic structural diagram of a device for using log information according to Embodiment 3 of the present invention. The device includes an acquiring module 41 and a sending module 42.

The acquiring module 41 is configured to acquire log information, which is corresponding to an instant messaging identifier, of a user, where the log information includes a time unit and a working status of the user in the time unit.

The sending module 42 is configured to send the log information acquired by the acquiring module 41 to a first instant messaging client, so that the first instant messaging client displays the working status of the user according to the log information, where the instant messaging identifier is corresponding to an instant messaging object included in the first instant messaging client.

In another embodiment of the present invention, the device further includes a log query request sending module 43.

The log query request sending module 43 is configured to, before the log information, which is corresponding to the instant messaging identifier, of the user is acquired, receive a log information acquiring request sent by the first instant messaging client, where the log information acquiring request includes the instant messaging identifier; and send a log query request that carries the instant messaging identifier to a log server.

The acquiring module 41 is specifically configured to receive the log information that is sent by the log server and is corresponding to the instant messaging identifier.

In another embodiment of the present invention, the device further includes a log query request sending module 43.

The log query request sending module 43 is configured to, before the log information, which is corresponding to the instant messaging identifier, of the user is acquired, receive a log information acquiring request sent by the first instant messaging client, where the log information acquiring request includes the instant messaging identifier; and send, to a second instant messaging client corresponding to the instant messaging identifier, a log query request that carries the instant messaging identifier.

The acquiring module 41 is specifically configured to receive the log information that is sent by the second instant messaging client corresponding to the instant messaging identifier and is corresponding to the instant messaging identifier.

In another embodiment of the present invention, the log information of the user includes the time unit and the working status of the user in the time unit.

The sending module 42 is specifically configured to send the time unit and the working status of the user in the time unit to the first instant messaging client.

It should be noted that, the device described in Embodiment 3 of the present invention may be implemented in a hardware manner, or may be implemented in a software manner. The device may be a PC, or may be a mobile terminal, which is not limited herein.

### Embodiment 4

As shown in FIG. 5, FIG. 5 is a schematic structural diagram of a device for using log information according to Embodiment 4 of the present invention. The device includes a receiving module 51 and a display module 52.

The receiving module 51 is configured to receive log information, which is corresponding to an instant messaging identifier, of a user, where the log information includes a time unit and a working status of the user in the time unit.

The display module 52 is configured to display the working status of the user according to the log information received by the receiving module 51, where the instant messaging identifier is corresponding to an instant messaging object included in the first instant messaging client, and the log information includes the time unit and the working status of the user in the time unit.

In another embodiment of the present invention, the device further includes an acquiring request sending module 53.

The acquiring request sending module 53 is configured to, before the log information, which is corresponding to the instant messaging identifier, of the user is received, send a log information acquiring request, where the log information acquiring request includes the instant messaging identifier.

Specifically, the receiving module 51 is configured to receive the time unit and the working status of the user in the time unit, where the user is corresponding to the instant messaging identifier.

The display module 52 is specifically configured to display, in a time sequence and near an icon location corresponding to the instant messaging identifier of the user, the time unit and the working status of the user in the time unit.

It should be noted that, the device described in Embodiment 4 of the present invention may be implemented in a hardware manner, and may also be implemented in a software manner. The device may be a desktop client on a PC, or may be an application client in a mobile terminal, which is not limited herein.

### Embodiment 5

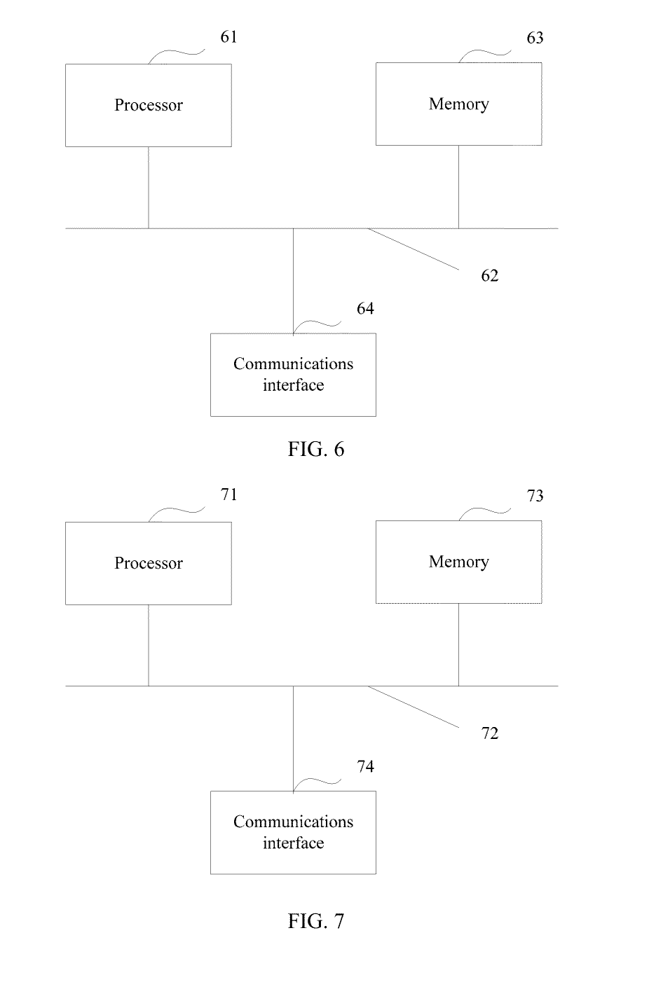

As shown in FIG. 6, FIG. 6 is a schematic structural diagram of a device for using log information according to Embodiment 5 of the present invention. The device has a function of executing Embodiment 1 and Embodiment 3 of the present invention. The device may use a structure of a general computer system; and the computer system may be specifically a processor-based computer. An entity of the device includes at least one processor 61, a communications bus 62, a memory 63, and at least one communications interface 64.

The processor 61 may be a general central processing unit (CPU), a microprocessor, an application-specific integrated circuit (ASIC), or one or more integrated circuits that are configured to control program execution of the solutions of the present invention.

The communications bus 62 may include a path, over which information is transferred between the foregoing components. The communications interface 64, by using any apparatus of a transceiver type, is configured to communicate with another device or communications network, such as an Ethernet, a radio access network (RAN), or a wireless local area network (WLAN).

The computer system includes one or more memories 63, which may be a read-only memory (read-only memory, ROM) or another type of static storage device that can store static information and instructions, a random access memory (random access memory, RAM) or another type of dynamic storage device that can store information and instructions; or may be an electrically erasable programmable read-only memory (EEPROM), a compact disc read-only memory (CD-ROM), other compact disc storage, optical disc (including a compact disc, a laser disc, an optical disc, a digital versatile disc, and a blu-ray disc, or the like) storage, and disk storage medium, another disk storage device, or any other medium that can be used to carry or store expected program code that has an instruction or a digital structure form and that can be accessed by a computer, which, however, is not limited herein. These memories are connected to the processor by using the bus.

The memory 63 is configured to store application program code that executes the solutions of the present invention, where the application program code that executes the solutions of the present invention is saved in the storage, and execution thereof is controlled by the processor 61. The processor 61 is configured to execute the application program code stored in the memory 63.

In a possible implementation manner, when the foregoing application program code is executed by the processor 61, the processor 61 is configured to:

acquire log information, which is corresponding to an instant messaging identifier, of a user, where the log information includes a time unit and a working status of the user in the time unit; and

send the log information to a first instant messaging client, so that the first instant messaging client displays the working status of the user according to the log information, where the instant messaging identifier is corresponding to an instant messaging object included in the first instant messaging client.

In another embodiment of the present invention, the processor 61 is further configured to:

before the log information, which is corresponding to the instant messaging identifier, of the user is acquired, receive a log information acquiring request sent by the first instant messaging client, where the log information acquiring request includes the instant messaging identifier;

send a log query request that carries the instant messaging identifier to a log server; and

receive the log information that is sent by the log server and is corresponding to the instant messaging identifier.

In another embodiment of the present invention, the processor 61 is further configured to:

before the log information, which is corresponding to the instant messaging identifier, of the user is acquired, receive a log information acquiring request sent by the first instant messaging client, where the log information acquiring request includes the instant messaging identifier;

send, to a second instant messaging client corresponding to the instant messaging identifier, a log query request that carries the instant messaging identifier; and

receive the log information that is sent by the second instant messaging client corresponding to the instant messaging identifier and is corresponding to the instant messaging identifier.

In another embodiment of the present invention, the processor 61 is specifically configured to:

send the time unit and the working status of the user in the time unit to the first instant messaging client.

In this embodiment, when the application program code is executed by the processor, for processing of the device and a method of interaction between the device and another network element, refer to the foregoing method embodiments, which are not detailed herein again.

A device provided in this embodiment implements that: log information of a user is displayed in an instant messaging client that has an instant messaging identifier of the user; when the user performs communication by using instant messaging software, a peer end in communication can acquire a future status of the user in time, and the user can acquire a future status of the peer end in communication in time, which helps either communication party select an appropriate time to initiate communication with a peer end in communication, thereby greatly enhancing efficiency of communication performed by using the instant messaging software.

### Embodiment 6

As shown in FIG. 7, FIG. 7 is a schematic structural diagram of a device for using log information according to Embodiment 6 of the present invention. The device has a function of executing Embodiment 2 and Embodiment 4 of the present invention. The device may use a structure of a general computer system; and the computer system may be specifically a processor-based computer. An entity of the device includes at least one processor 71, a communications bus 72, a memory 73, and at least one communications interface 74.

The processor 71 may be a general central processing unit (CPU), a microprocessor, an application-specific integrated circuit (application-specific integrated circuit, ASIC), or one or more integrated circuits that are configured to control program execution of the solutions of the present invention.

The communications bus 72 may include a path, over which information is transferred between the foregoing components. The communications interface 74, by using any apparatus of a transceiver type, is configured to communicate with another device or communications network, such as an Ethernet, a radio access network (RAN), or a wireless local area network (Wireless Local Area Networks, WLAN).

The computer system includes one or more memories 73, which may be a read-only memory (read-only memory, ROM) or another type of static storage device that can store static information and instructions, a random access memory (random access memory, RAM) or another type of dynamic storage device that can store information and instructions; and may also be an electrically erasable programmable read-only memory (Electrically Erasable Programmable Read-Only Memory, EEPROM), a compact disc read-only memory (Compact Disc Read-Only Memory, CD-ROM), other compact disc storage, optical disc (including a compact disc, a laser disc, an optical disc, a digital versatile disc, and a blu-ray disc, or the like) storage, and disk storage medium, another disk storage device, or any other medium that can be used to carry or store expected program code that has an instruction or digital structure form and that can be accessed by a computer, which, however, is not limited herein. These memories are connected to the processor by using the bus.

The memory 73 is configured to store application program code that executes the solutions of the present invention, where the application program code that executes the solutions of the present invention is saved in the storage, and execution thereof is controlled by the processor 71. The processor 71 is configured to execute the application program code stored in the memory 73.

In a possible implementation manner, when the foregoing application program code is executed by the processor 71, the processor 71 is configured to:

receive log information, which is corresponding to an instant messaging identifier, of a user, where the log information includes a time unit and a working status of the user in the time unit; and

display the working status of the user according to the log information, where the instant messaging identifier is corresponding to an instant messaging object included in a first instant messaging client.

In another embodiment of the present invention, the processor 71 is further configured to:

before the log information, which is corresponding to the instant messaging identifier, of the user is received, send a log information acquiring request, where the log information acquiring request includes the instant messaging identifier.

In another embodiment of the present invention, the processor 71 is specifically configured to:

receive the time unit and the working status of the user in the time unit, where the user is corresponding to the instant messaging identifier; and

display, in a time sequence and near an icon location corresponding to the instant messaging identifier of the user, the time unit and the working status of the user in the time unit.

In this embodiment, when the application program code is executed by the processor, for processing of the device and a method of interaction between the device and another network element, refer to the foregoing method embodiments, which are not detailed herein again.

A device provided in this embodiment implements that: log information of a user is displayed in an instant messaging client that has an instant messaging identifier of the user; when the user performs communication by using instant messaging software, a peer end in communication can acquire a future status of the user in time, and the user can acquire a future status of the peer end in communication in time, which helps either communication party select an appropriate time to initiate communication with a peer end in communication, thereby greatly enhancing efficiency of communication performed by using the instant messaging software.

A person skilled in the art should understand that the embodiments of the present invention may be provided as a method, an apparatus (device), or a computer program product. Therefore, the present invention may use a form of hardware only embodiments, software only embodiments, or embodiments with a combination of software and hardware. Moreover, the present invention may use a form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the apparatus (device), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some preferred embodiments of the present invention have been described, persons skilled in the art can make changes and modifications to these embodiments once they learn the basic inventive concept. Therefore, the following claims are intended to be construed as to cover the preferred embodiments and all changes and modifications falling within the scope of the present invention.

Obviously, a person skilled in the art can make various modifications and variations to the present invention without departing from the spirit and scope of the present invention. The present invention is intended to cover these modifications and variations provided that they fall within the scope of protection defined by the following claims and their equivalent technologies.

What is claimed is:

1. A method for using log information, wherein the method comprises:
acquiring log information, which is corresponding to an instant messaging identifier, of a user, wherein the log information comprises a time unit and a working status of the user in the time unit; and
sending the log information to a first instant messaging client, so that the first instant messaging client displays the working status of the user according to the log information, wherein the instant messaging identifier is corresponding to an instant messaging object comprised in the first instant messaging client.

2. The method according to claim 1, wherein before the acquiring log information, which is corresponding to an instant messaging identifier, of a user, the method further comprises:
receiving a log information acquiring request sent by the first instant messaging client, wherein the log information acquiring request comprises the instant messaging identifier; and
sending a log query request that carries the instant messaging identifier to a log server; wherein
the acquiring log information, which is corresponding to an instant messaging identifier, of a user comprises:
receiving the log information that is sent by the log server and is corresponding to the instant messaging identifier.

3. The method according to claim 1, wherein before the acquiring log information, which is corresponding to an instant messaging identifier, of a user, the method further comprises:
receiving a log information acquiring request sent by the first instant messaging client, wherein the log information acquiring request comprises the instant messaging identifier; and
sending, to a second instant messaging client corresponding to the instant messaging identifier, a log query request that carries the instant messaging identifier; wherein
the acquiring log information, which is corresponding to an instant messaging identifier, of a user comprises:
receiving the log information that is sent by the second instant messaging client corresponding to the instant messaging identifier and is corresponding to the instant messaging identifier.

4. The method according to claim 1, wherein the log information of the user comprises the time unit and the working status of the user in the time unit; and
the sending the log information to a first instant messaging client comprises:
sending the time unit and the working status of the user in the time unit to the first instant messaging client.

5. A method for using log information, wherein the method comprises:
receiving, by a first instant messaging client, log information, which is corresponding to an instant messaging identifier, of a user, wherein the log information comprises a time unit and a working status of the user in the time unit; and
displaying the working status of the user according to the log information, wherein the instant messaging identifier is corresponding to an instant messaging object comprised in the first instant messaging client.

6. The method according to claim 5, wherein before the receiving, by a first instant messaging client, log information, which is corresponding to an instant messaging identifier, of a user, the method further comprises:
sending, by the first instant messaging client, a log information acquiring request, wherein the log information acquiring request comprises the instant messaging identifier.

7. The method according to claim 5, wherein the receiving, by a first instant messaging client, log information, which is corresponding to an instant messaging identifier, of a user comprises:
receiving, by the first instant messaging client, the time unit and the working status of the user in the time unit, wherein the user is corresponding to the instant messaging identifier; and
the displaying the working status of the user according to the log information comprises:
displaying, in a time sequence and near an icon location corresponding to the instant messaging identifier of the user, the time unit and the working status of the user in the time unit.

8. A device for using log information, wherein the device comprises:
an acquiring module, configured to acquire log information, which is corresponding to an instant messaging identifier, of a user, wherein the log information comprises a time unit and a working status of the user in the time unit; and
a sending module, configured to send the log information acquired by the acquiring module to a first instant messaging client, so that the first instant messaging client displays the working status of the user according to the log information, wherein the instant messaging identifier is corresponding to an instant messaging object comprised in the first instant messaging client.

9. The device according to claim 8, wherein the device further comprises:
a log query request sending module, configured to, before the log information, which is corresponding to the instant messaging identifier, of the user is acquired, receive a log information acquiring request sent by the first instant messaging client, wherein the log information acquiring request comprises the instant messaging identifier; and send a log query request that carries the instant messaging identifier to a log server; wherein
the acquiring module is specifically configured to receive the log information that is sent by the log server and is corresponding to the instant messaging identifier.

10. The device according to claim 8, wherein the device further comprises:
a log query request sending module, configured to, before the log information, which is corresponding to the instant messaging identifier, of the user is acquired, receive a log information acquiring request sent by the first instant messaging client, wherein the log information acquiring request comprises the instant messaging identifier; and send, to a second instant messaging client corresponding to the instant messaging identifier, a log query request that carries the instant messaging identifier; wherein
the acquiring module is specifically configured to receive the log information that is sent by the second instant messaging client corresponding to the instant messaging identifier and is corresponding to the instant messaging identifier.

11. The device according to claim 8, wherein the log information of the user comprises the time unit and the working status of the user in the time unit; and
the sending module is specifically configured to send the time unit and the working status of the user in the time unit to the first instant messaging client.

12. A device for using log information, wherein the device comprises:
a receiving module, configured to receive log information, which is corresponding to an instant messaging identifier, of a user, wherein the log information comprises a time unit and a working status of the user in the time unit; and
a display module, configured to display the working status of the user according to the log information received by the receiving module, wherein the instant messaging identifier is corresponding to an instant messaging object comprised in a first instant messaging client.

13. The device according to claim 12, wherein the device further comprises:
an acquiring request sending module, configured to, before the log information, which is corresponding to the instant messaging identifier, of the user is received, send a log information acquiring request, wherein the log information acquiring request comprises the instant messaging identifier.

14. The device according to claim 12, wherein:
the receiving module is specifically configured to receive the time unit and the working status of the user in the time unit, wherein the user is corresponding to the instant messaging identifier; and
the display module is specifically configured to display, in a time sequence and near an icon location corresponding to the instant messaging identifier of the user, the time unit and the working status of the user in the time unit.

15. The device according to claim 13, wherein:
the receiving module is specifically configured to receive the time unit and the working status of the user in the time unit, wherein the user is corresponding to the instant messaging identifier; and
the display module is specifically configured to display, in a time sequence and near an icon location corresponding to the instant messaging identifier of the user, the time unit and the working status of the user in the time unit.
